(19) United States
(12) Patent Application Publication
(10) Pub. No.: US 2017/0120106 A1
(43) Pub. Date: May 4, 2017

(54) Method for Authenticating Use of an Activity Tracking Device

(71) Applicant: MASTERCARD ASIA/PACIFIC PTE LTD, Singapore (SG)

(72) Inventors: Tobias Puehse, Singapore (SG); Sin Jian Tan, Singapore (SG); Jie Zhang, Singapore (SG); Douglas Teck Yong Tan, Singapore (SG); Noor Ali Nizar Ali, Singapore (SG); Naman Aggarwal, Singapore (SG); Yong Wei Chin, Singapore (SG)

(21) Appl. No.: 15/340,668

(22) Filed: Nov. 1, 2016

(30) Foreign Application Priority Data
Nov. 2, 2015 (SG) 10201509024T

(51) Int. Cl. A63B 24/00; G06Q 20/40; G06Q 20/32; G09B 5/02

(52) U.S. Cl. CPC A63B 24/0021; G09B 5/02; G06Q 20/405; G06Q 20/3224; A63B 2024/0025; A63B 2220/62; A63B 2220/17; A63B 2230/04; A63B 2230/42

(57) ABSTRACT

A data processor implemented method for authenticating use of an activity tracking device by a user is provided. The method includes obtaining a plurality of first markers, wherein each of the first markers includes a location and time-stamp of the activity tracking device when the activity tracking device is tracking at least one parameter of the user. The method also includes obtaining a plurality of second markers from a transaction data storage, wherein each of the second markers includes a location and time-stamp of an electronic transaction made by the user using at least one payment device of the user. The method further includes comparing the locations of the plurality of first markers with the locations of the plurality of second markers, and determining, based on the comparison, whether the activity tracking device is regularly in use by the user.

### CROSS REFERENCE TO RELATED APPLICATIONS

This application claims the benefit of Singapore Patent Application No. 10201509024T filed Nov. 2, 2015, which is hereby incorporated by reference in its entirety.

### BACKGROUND

Embodiments of the present disclosure relate to a method for authenticating use of an activity tracking device by a user.

Currently, an increasing number of individuals are becoming more health-conscious, and they use apps on their mobile phones and/or wearable activity-tracking devices to keep track of the activities/exercises which they have participated in. Typically, a record of the activities/exercises which they have participated in is stored on the individuals' mobile phone/remote storage account.

In addition, the increasing number of health-conscious individuals are a highly coveted demographic which insurance companies would like to reach out to, as their healthy lifestyles typically lead to more healthy individuals which may lead to a lower incidence of medical claims. Current practices by the insurance companies to attract the health-conscious demographic include partnering with third party merchants to offer special promotions at the third party merchants, but such practices have questionable effectiveness as the third party merchants may not be appealing to the health-conscious demographic. It is noted that other organizations other than insurance companies are also keen to engage with the health-conscious demographic.

However, there is currently no way for the organizations to check if the health-conscious demographic are regularly using their apps on their mobile phones and/or wearable activity-tracking devices whenever they engage in their physical activities. In view of this deficiency, the organizations are unable to ascertain if their initiatives to engage the health-conscious demographic are effective. This uncertainty is undesirable.

### BRIEF DESCRIPTION

A data processor implemented method for authenticating use of an activity tracking device by a user is provided. The method includes obtaining a plurality of first markers, each of the first markers including a location and time-stamp of the activity tracking device when the activity tracking device is tracking at least one parameter of the user, obtaining a plurality of second markers from a transaction data storage, each of the second markers including a location and time-stamp of an electronic transaction made by the user using at least one payment device of the user, comparing the locations of the plurality of first markers with the locations of the plurality of second makers, and based on the comparison, determining whether the activity tracking device is regularly in use by the user.

In some embodiments, the comparison provides an affirmative outcome if comparison findings lie within a threshold band, and provides a negative outcome if comparison findings lie outside of the threshold band.

The method can further include determining a “confidence” metric, wherein authenticating use of the activity tracking device by the user is dependent on the “confidence” metric. It is preferable that the “confidence” metric is a ratio of the affirmative outcomes to a sum of the affirmative outcomes and the negative outcomes over a pre-defined period of time. A value of the “confidence” metric of above 0.7 can indicate regular use of the activity tracking device by the user, while a value of the “confidence” metric of below 0.4 can indicate non-regular use of the activity tracking device by the user.

In some embodiments, the activity tracking device is configured to provide a location of the user. Moreover, the transaction data storage can be a payment gateway.

The at least one parameter of the user may be selected from, for example, heart rate, respiration rate, number of footsteps, number of climbing steps, distance ran, distance swam, distance cycled, and so forth.

In another aspect, a non-transitory computer readable storage medium embodying thereon a program of computer readable instructions is provided. The program of computer readable instructions, when executed by one or more processors of a first server in communication with at least one other server, cause the first server to perform a method for authenticating use of an activity tracking device by a user. The method includes the steps of obtaining a plurality of first markers, each of the first markers including a location and time-stamp of the activity tracking device when the activity tracking device is tracking at least one parameter of the user, obtaining a plurality of second markers from a transaction data storage, each of the second markers including a location and time-stamp of an electronic transaction made by the user using at least one payment device of the user, comparing the locations of the plurality of first markers with the locations of the plurality of second makers, and based on the comparison, determining whether the activity tracking device is regularly in use by the user.

The comparison may provide an affirmative outcome if comparison findings lie within a threshold band, and provides a negative outcome if comparison findings lie outside of the threshold band.

The storage medium can further include determining a “confidence” metric, wherein authenticating use of the activity tracking device by the user is dependent on the “confidence” metric. The “confidence” metric may be a ratio of the affirmative outcomes to a sum of the affirmative outcomes and the negative outcomes over a pre-defined period of time. A value of the “confidence” metric of above 0.7 can indicate regular use of the activity tracking device by the user, while a value of the “confidence” metric of below 0.4 can indicate non-regular use of the activity tracking device by the user.

In some embodiments, the activity tracking device is configured to provide a location of the user. Furthermore, the transaction data storage can be a payment gateway.

The at least one parameter of the user may be selected from, for example, heart rate, respiration rate, number of footsteps, number of climbing steps, distance ran, distance swam, distance cycled, and so forth.

In a further aspect, a non-transitory computer readable storage medium embodying thereon a program of computer readable instructions is provided. The program of computer readable instructions, when executed by one or more processors of a mobile device in communication with at least one other server, cause the mobile device to perform a method for authenticating use of an activity tracking device by a user. The method includes the steps of obtaining a plurality of first markers, each of the first markers including a location and time-stamp of the activity tracking device when the activity tracking device is tracking at least one parameter of the user, obtaining a plurality of second markers from a transaction data storage, each of the second markers including a location and time-stamp of an electronic transaction made by the user using at least one payment device of the user, comparing the locations of the plurality of first markers with the locations of the plurality of second makers, and based on the comparison, determining whether the activity tracking device is regularly in use by the user.

The comparison may provide an affirmative outcome if comparison findings lie within a threshold band, and provides a negative outcome if comparison findings lie outside of the threshold band.

The storage medium can further include determining a “confidence” metric, wherein authenticating use of the activity tracking device by the user is dependent on the “confidence” metric. The “confidence” metric may be a ratio of the affirmative outcomes to a sum of the affirmative outcomes and the negative outcomes over a pre-defined period of time. A value of the “confidence” metric of above 0.7 can indicate regular use of the activity tracking device by the user, while a value of the “confidence” metric of below 0.4 can indicate non-regular use of the activity tracking device by the user.

The activity tracking device may be configured to provide a location of the user. Furthermore, the transaction data storage can be a payment gateway.

The at least one parameter of the user may be selected from, for example, heart rate, respiration rate, number of footsteps, number of climbing steps, distance ran, distance swam, distance cycled and so forth.

In another aspect, a system for authenticating use of an activity tracking device by a user is provided. The system includes at least one activity tracking device configured to track at least one parameter of the user, a first server configured to store a plurality of first markers, each of the first markers including a location and time-stamp of the activity tracking device when the activity tracking device is tracking at least one parameter of the user, a transaction data storage configured to store a plurality of second markers, each of the second markers including a location and time-stamp of an electronic transaction made by the user using at least one payment device of the user, and a second server configured to compare the locations of the plurality of first markers with the locations of the plurality of second markers, and based on the comparison, determining whether the activity tracking device is regularly in use by the user.

The comparison may provide an affirmative outcome if comparison findings lie within a threshold band, and provides a negative outcome if comparison findings lie outside of the threshold band.

In some embodiments, authenticating use of the activity tracking device by the user may be dependent on a “confidence” metric. The “confidence” metric can be a ratio of the affirmative outcomes to a sum of the affirmative outcomes and the negative outcomes over a pre-defined period of time. A value of the “confidence” metric of above 0.7 can indicate regular use of the activity tracking device by the user, while a value of the “confidence” metric of below 0.4 can indicate non-regular use of the activity tracking device by the user.

The activity tracking device is configured to provide a location of the user. In addition, the transaction data storage can be a payment gateway.

The at least one parameter of the user is selected from, for example, heart rate, respiration rate, number of footsteps, number of climbing steps, distance ran, distance swam, distance cycled and so forth.

### BRIEF DESCRIPTION OF THE DRAWINGS

In order that the present disclosure may be fully understood and readily put into practical effect, there shall now be described by way of non-limitative example only, certain embodiments of the present disclosure, the description being with reference to the accompanying illustrative figures, in which:

FIG. 1 shows a schematic overview of a method according to certain embodiments of the present disclosure.

FIG. 2 shows a process flow of a data processor implemented method according to certain embodiments of the present disclosure.

FIG. 3 shows a schematic view of a user device used in the method shown in FIG. 2.

FIG. 4 shows a schematic view of a server used in the method shown in FIG. 2.

FIG. 5 shows an overview of a system according to certain embodiments of the present disclosure.

### DETAILED DESCRIPTION

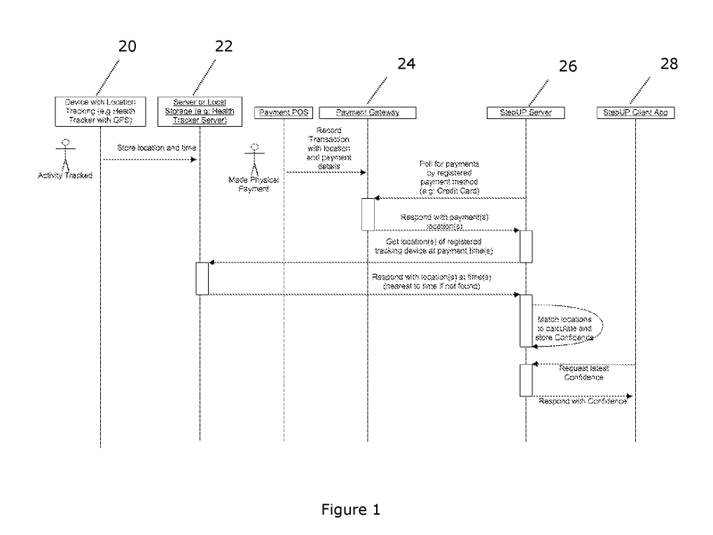

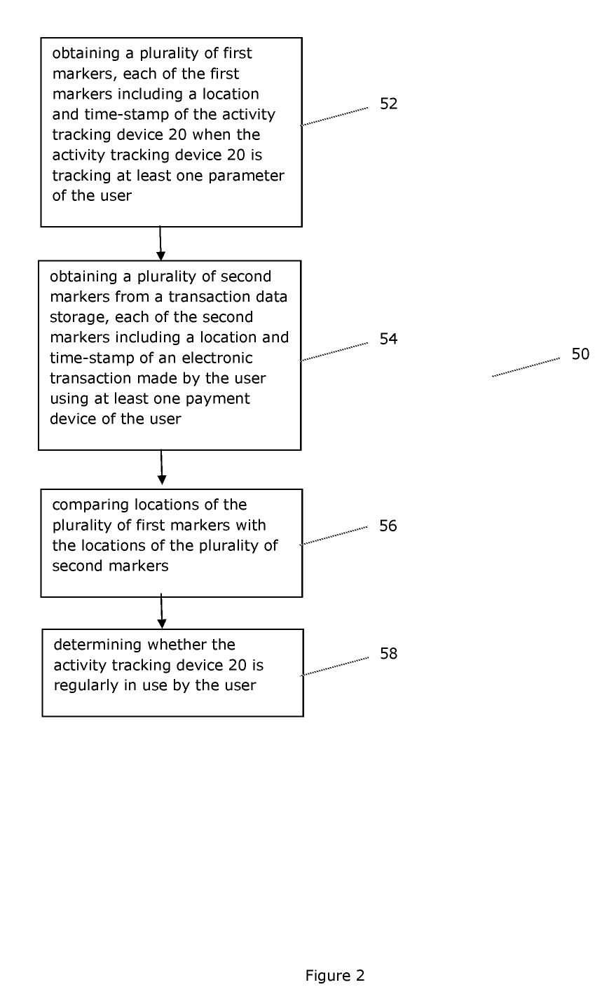

Certain embodiments of the present disclosure are described with reference to FIGS. 1 and 2. Embodiments provide a data processor implemented method for authenticating use of an activity tracking device by a user, by tracking the user's electronic transactions. Electronic transactions may include payment transactions or non-payment transactions (such as checking an account balance) made using payment devices. As used herein, the terms “payment device”, “transaction card,” “financial transaction card,” and “payment card” refer to any suitable electronic transaction device, such as a credit card, a debit card, a prepaid card, a charge card, a membership card, a promotional card, a frequent flyer card, an identification card, a gift card, and/or any other device that may hold payment account information, such as wearable devices, mobile phones, smartphones, personal digital assistants (PDAs), key fobs, and/or computers. Payment devices are typically uniquely tied to a consumer or card holder account.

Electronic transactions can also include, for example, point-of-sale card-based transactions, online transactions where an IP address of the transaction can be determined, mobile transactions where the mobile device used for the transaction is associated with a particular user, and so forth.

In at least some embodiments, the method to determine the regularity of use of an activity tracking device by a user allows an organization to understand activity behavior of the user and may lead to effective engagement of the organization and the user. In addition, it may also be a way whereby inappropriate/fraudulent use of the activity tracking device can be detected as well.

FIG. 2 shows the steps of an exemplary method 50, while FIG. 1 shows a context in which the steps are carried out. The method 50 will be depicted in a flow diagram (FIG. 2), and each of the blocks of the flow diagram may be executed by one or more data processors or a portion of the data processor (for example, a single core of a multi-core processor). The processes may be embodied in a non-transient machine-readable and/or computer-readable medium for configuring a computer system to execute the method. One or more software modules may be stored within and/or transmitted to a computer system memory to configure the computer system to carry out the tasks indicated in each of the blocks of the flow diagram.

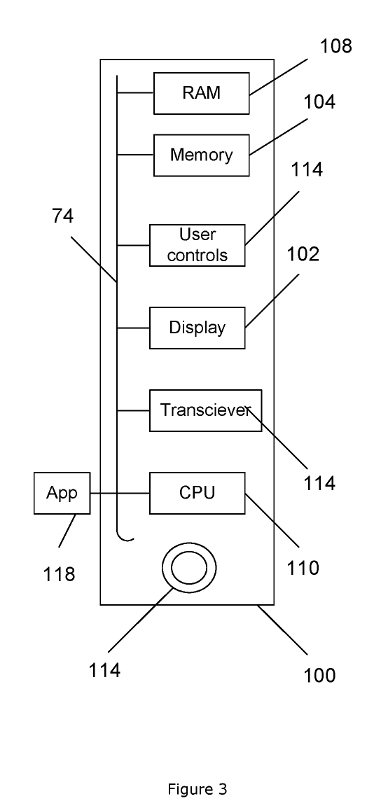

The method 50 can be carried out on a mobile device 100. The mobile device 100 is a handheld device, such as a smartphone or a tablet computer, such as one manufactured by Apple™, LG™, HTC™, Samsung™, and Motorola™. An exemplary embodiment of the mobile device 100 is shown in FIG. 3. As shown, the device 100 includes the following components in electronic communication via a bus 106:
a display 102;
non-volatile memory 104;
random access memory (“RAM”) 108;
N processing components 110;
a transceiver component 112 that includes N transceivers; and
user controls 114.

Although the components depicted in FIG. 3 represent physical components, FIG. 3 is not intended to be a hardware diagram. Thus, many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

The display 102 generally operates to provide a presentation of content to a user, and may be realized by any of a variety of displays (e.g., CRT, LCD, HDMI, micro-projector, and OLED displays). And in general, the non-volatile memory 104 functions to store (e.g. persistently store) data and executable code including code that is associated with the functional components of the method. In some embodiments, for example, the non-volatile memory 104 includes bootloader code, modem software, operating system code, file system code, and code to facilitate the implementation of one or more portions of the method as well as other components well known to those of ordinary skill in the art that are not depicted for simplicity.

In many implementations, the non-volatile memory 104 is realized by flash memory (e.g., NAND or ONENAND memory), but it is certainly contemplated that other memory types may be utilized as well. Although it may be possible to execute the code from the non-volatile memory 104, the executable code in the non-volatile memory 104 is typically loaded into RAM 108 and executed by one or more of the N processing components 110.

The N processing components 110 in connection with RAM 108 generally operate to execute the instructions stored in non-volatile memory 104 to effectuate the functional components. As one of ordinarily skill in the art will appreciate, the N processing components 110 may include a video processor, modem processor, DSP, graphics processing unit (GPU), and other processing components.

The transceiver component 112 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

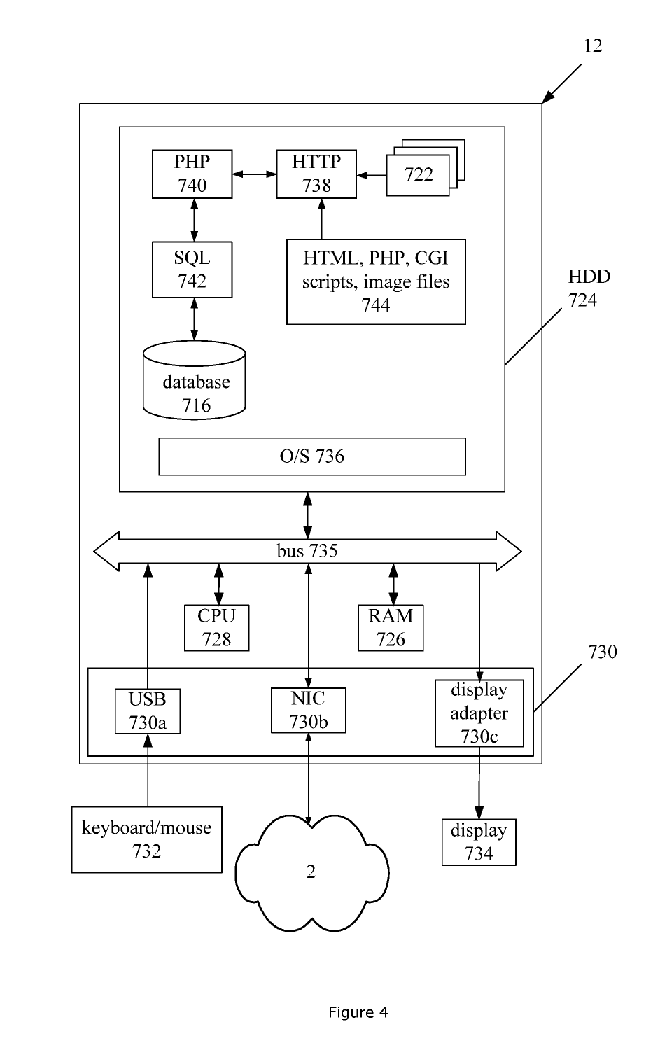

The method 50 can also be carried out by a server 12 as shown in FIG. 4. The server 12 is able to communicate with the mobile device 100 over a communications network 2 using standard communication protocols.

It should be appreciated that the method 50 can be configured to be performed in a variety of ways. The steps can be implemented entirely by software to be executed on standard computer server hardware, which may include one hardware unit or different computer hardware units distributed over various locations, some of which may require the communications network 2 for communication. A number of the components or parts thereof may also be implemented by application specific integrated circuits (ASICs) or field programmable gate arrays.

In FIG. 4, the server 12 is a commercially available server computer system based on a 32 bit or a 64 bit Intel architecture, and the processes and/or methods executed or performed by the computer server 12 are implemented in the form of programming instructions of one or more software components or modules 722 stored on non-volatile (e.g., hard disk) computer-readable storage 724 associated with the server 12. At least parts of the software modules 722 could alternatively be implemented as one or more dedicated hardware components, such as application-specific integrated circuits (ASICs) and/or field programmable gate arrays (FPGAs).

The server 12 includes at least one or more of the following standard, commercially available, computer components, all interconnected by a bus 735:

1. random access memory (RAM) 726;

2. at least one computer processor 728, and

3. external computer interfaces 730:

a. universal serial bus (USB) interfaces 730a, at least one of which is connected to one or more user-interface devices, such as a keyboard, a pointing device (e.g., a mouse 732 or touchpad);

b. a network interface connector (NIC) 730b which connects the server 12 to a data communications network, such as the Internet 2; and

c. a display adapter 730c, which is connected to a display device 734, such as a liquid-crystal display (LCD) panel device.

The server 12 includes a plurality of standard software modules, including:

1. an operating system (OS) 736 (e.g., Linux or Microsoft Windows);

2. web server software 738 (e.g., Apache, available at http://www.apache.org);

3. scripting language modules 740 (e.g., personal home page or PHP, available at http://www.php.net, or Microsoft ASP); and

4. structured query language (SQL) modules 742 (e.g., MySQL, available from http://www.mysql.com), which allow data to be stored in and retrieved/accessed from an SQL database 716.

Together, the web server 738, scripting language 740, and SQL modules 742 provide the server 12 with the general ability to allow users of the Internet 2 with mobile device 100 equipped with standard web browser software to access the server 12 and, in particular, to provide data to and receive data from the database 716. It will be understood by those skilled in the art that the specific functionality provided by the server 12 to such users is provided by scripts accessible by the web server 738, including the one or more software modules 722 implementing the processes performed by the server 12, and also any other scripts and supporting data 744, including markup language (e.g., HTML, XML) scripts, PHP (or ASP), and/or CGI scripts, image files, style sheets, and the like.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the disclosure. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the server 12 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 12 normally processes information according to a program (a list of internally stored instructions, such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

In one embodiment, a method 50 for authenticating use of an activity tracking device by a user is provided. The method 50 can be carried out by one of the servers communicating with other servers, or by a mobile device communicating with other servers in the course of carrying out the method 50. In particular, the method 50 is carried out by tracking the user's electronic transactions. It should be appreciated that the electronic transactions should be locatable in relation to where the transaction was made, and can include, for example, point-of-sale card-based transactions, online (card not present) transactions where an IP address of the transaction can be determined, mobile transactions where the mobile device used for the transaction is associated with a particular user, and so forth.

The activity tracking device is configured to provide a location of the user, and can include, for example, a mobile phone (like mobile device 100), an activity wristband, a smartwatch, and the like. The activity tracking device is also configured to track at least one parameter of the user, the at least one parameter being, for example, heart rate, respiration rate, number of footsteps, number of climbing steps, distance ran, distance swam, distance cycled, and the like.

The method 50 includes obtaining a plurality of first markers from a first server 22 (52), whereby each of the first markers includes location and time-stamp of the activity tracking device 20 when the user is carrying out an activity with the activity tracking device 20. The first markers are obtained at pre-determined intervals or whenever the activity tracking device 20 has a data network connection. The location can be in the form of GPS coordinates or an IP address, for example. For example, in the instance when the location is an IP address, the activity tracking device 20 should also be connected to a data network and should be allocated an IP address. It should be appreciated that the plurality of first markers are uploaded to the first server 22 from the activity tracking device 20 using a wireless communications technology, such as, for example, Wifi, 3G, 4G, Bluetooth™, and the like.

The method 50 also includes obtaining a plurality of second markers from a payment gateway 24 (54), where each of the second markers includes a location and time-stamp of an electronic transaction made by the user using at least one payment device of the user. It should be noted that the payment gateway 24 can be administered by a third party who is not concerned about whether the user regularly uses the activity tracking device 20. The payment gateway 24 can be a transaction data storage which stores transaction data. Yet again, the location can be in the form of GPS coordinates or an IP address.

In addition, the method 50 includes comparing locations of the plurality of first markers with the locations of the plurality of second markers (56), the comparison being carried out at a second server 26. It should be appreciated that the comparison can also be carried out at the first server 22. The second server 26 can be used when access to the first server 22 is restricted, for example, when the first server 22 and the second server 26 are administered by different entities.

It should be noted that the comparison which is carried out provides an affirmative outcome if comparison findings lie within a threshold band, and provides a negative outcome if comparison findings lie outside of the threshold band. The threshold band can include, for example, distance and time limits. For the sake of illustration, if the threshold band includes a distance limit of one kilometer and a time limit of one hour, the affirmative outcome will result where an activity was carried out less than one hour ago, and an electronic transaction was carried out within one kilometer of where the activity was carried out. Conversely, a negative outcome will result where an activity was carried out less than one hour ago, and an electronic transaction was carried out at more than one kilometer of where the activity was carried out.

Finally, the method 50 includes determining if the activity tracking device 20 is regularly in use by the user. The manner pertaining to determination of whether the activity tracking device 20 is regularly in use by the user depends upon determining a “confidence” metric. The “confidence” metric is a ratio of the affirmative outcomes to a sum of the affirmative outcomes and the negative outcomes over a pre-defined period of time, the determination of regularity of use of the activity tracking device by the user being dependent on the obtained “confidence” metric. For the sake of illustration, a value of “confidence” metric of above 0.7 can indicate regular use of the activity tracking device by the user.

Similarly, for the sake of illustration, a value of “confidence” metric of below 0.4 can indicate a situation where the activity tracking device 20 is not regularly used by the user. In addition, a value of “confidence” metric of below 0.4 can also indicate fraudulent practices when making electronic payments if the user is able to prove that the user regularly uses the activity tracking device 20.

The “confidence” metric can be accessible from the second server 26 using a data connection to the second server 26.

It should be noted that the method 50 allows determination of a likelihood of use of the activity tracking device 50 by the user. This can be critical in determining whether the activity tracking device 50 is regularly used by the appropriate user, or can lead to how the activity tracking device 20 can also become a tool in determining fraudulent practices when making electronic payments.

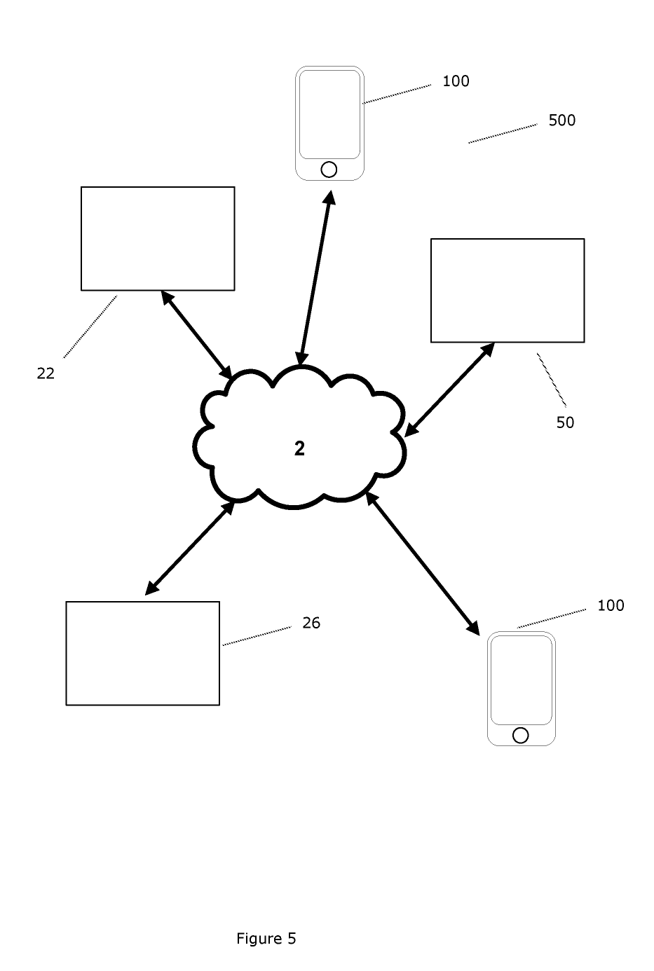

Referring to FIG. 5, an embodiment of a system 500 for authenticating use of an activity tracking device by a user is provided. The system 500 includes the first server 22 and the second server 26, their respective functions, at least as per the description in the preceding paragraphs, and their construction as per the aforementioned server 12. The system 500 also includes the payment gateway 24 (transaction data storage), and a plurality of activity tracking devices (in the form of mobile devices 100). It should be noted that the Internet 2 enables the respective elements of the system 500 to be communicatively connected to each other, and this can be via either a wireless connection or a cabled connection. The system 500 enables the method 50 to be carried out in a desired manner.

Whilst example embodiments of the present disclosure have been described in the foregoing description, it will be understood by those skilled in the technology concerned that many variations or modifications in details of design or construction may be made without departing from the present disclosure.

1. A data processor implemented method for authenticating use of an activity tracking device by a user, the method comprising:
obtaining a plurality of first markers, each of the first markers including a location and time-stamp of the activity tracking device when the activity tracking device is tracking at least one parameter of the user;
obtaining a plurality of second markers from a transaction data storage, each of the second markers including a location and time-stamp of an electronic transaction made by the user using at least one payment device of the user;
comparing the locations of the plurality of first markers with the locations of the plurality of second markers; and
determining, based on the comparison, whether the activity tracking device is regularly in use by the user.

2. The method of claim 1, wherein the comparison provides an affirmative outcome if comparison findings lie within a threshold band, and provides a negative outcome if comparison findings lie outside of the threshold band.

3. The method of claim 2, further comprising determining a confidence metric, wherein authenticating use of the activity tracking device by the user is dependent on the confidence metric.

4. The method of claim 3, wherein the confidence metric is a ratio of a number of affirmative outcomes to a sum of the number of affirmative outcomes and a number of negative outcomes over a pre-defined period of time.

5. The method of claim 3, wherein a value of the confidence metric of above 0.7 indicates regular use of the activity tracking device by the user.

6. The method of claim 3, wherein a value of the confidence metric of below 0.4 indicates non-regular use of the activity tracking device by the user.

7. The method of claim 1, wherein the activity tracking device is configured to provide a location of the user.

8. The method of claim 1, wherein the transaction data storage is a payment gateway.

9. The method of claim 1, wherein the at least one parameter of the user is at least one of heart rate, respiration rate, number of footsteps, number of climbing steps, distance ran, distance swam, and distance cycled.

10. A non-transitory computer readable storage medium embodying thereon a program of computer readable instructions which, when executed by one or more processors of a first server in communication with at least one other server, cause the first server to perform a method for authenticating use of an activity tracking device by a user, the method including:
obtaining a plurality of first markers, each of the first markers including a location and time-stamp of the activity tracking device when the activity tracking device is tracking at least one parameter of the user;
obtaining a plurality of second markers from a transaction data storage, each of the second markers including a location and time-stamp of an electronic transaction made by the user using at least one payment device of the user;
comparing the locations of the plurality of first markers with the locations of the plurality of second markers; and
determining, based on the comparison, whether the activity tracking device is regularly in use by the user.

11. (canceled)

12. (canceled)

13. (canceled)

14. (canceled)

15. (canceled)

16. (canceled)

17. (canceled)

18. (canceled)

19. A non-transitory computer readable storage medium embodying thereon a program of computer readable instructions which, when executed by one or more processors of a mobile device in communication with at least one other server, cause the mobile device to perform a method for authenticating use of an activity tracking device by a user, the method including:
obtaining a plurality of first markers, each of the first markers including a location and time-stamp of the activity tracking device when the activity tracking device is tracking at least one parameter of the user;
obtaining a plurality of second markers from a transaction data storage, each of the second markers including a location and time-stamp of an electronic transaction made by the user using at least one payment device of the user;
comparing the locations of the plurality of first markers with the locations of the plurality of second markers; and
determining, based on the comparison, whether the activity tracking device is regularly in use by the user.

20. (canceled)

21. (canceled)

22. (canceled)

23. (canceled)

24. (canceled)

25. (canceled)

26. (canceled)

27. (canceled)

28. A system for authenticating use of an activity tracking device by a user, the system comprising:
at least one activity tracking device configured to track at least one parameter of the user;
a first server configured to store a plurality of first markers, each of the first markers including a location and time-stamp of the activity tracking device when the activity tracking device is tracking at least one parameter of the user;
a transaction data storage configured to store a plurality of second markers, each of the second markers including a location and time-stamp of an electronic transaction made by the user using at least one payment device of the user; and
a second server configured to compare the locations of the plurality of first markers with the locations of the plurality of second markers, and based on the comparison, determining whether the activity tracking device is regularly in use by the user.

29. The system of claim 28, wherein the comparison provides an affirmative outcome if comparison findings lie within a threshold band, and provides a negative outcome if comparison findings lie outside of the threshold band.

30. The system of claim 29, wherein authenticating use of the activity tracking device by the user is dependent on a confidence metric.

31. The system of claim 30, wherein the confidence metric is a ratio of a number of affirmative outcomes to a sum of the number of affirmative outcomes and a number of negative outcomes over a pre-defined period of time.

32. The system of claim 30, wherein a value of the confidence metric of above 0.7 indicates regular use of the activity tracking device by the user.

33. The system of claim 30, wherein a value of the confidence metric of below 0.4 indicates non-regular use of the activity tracking device by the user.

34. The system of claim 28, wherein the activity tracking device is configured to provide a location of the user.

35. The system of claim 28, wherein the transaction data storage is a payment gateway.

36. The system of claim 28, wherein the at least one parameter of the user is at least one of heart rate, respiration rate, number of footsteps, number of climbing steps, distance ran, distance swam, and distance cycled.
